(19) United States
(12) Patent Application Publication
(10) Pub. No.: US 2025/0366467 A1
(43) Pub. Date: Dec. 4, 2025

(54) METHODS FOR FLUID RESUSCITATION OF AN ORGAN DONOR

(71) Applicant: VIRGINIA COMMONWEALTH UNIVERSITY, Richmond, VA (US)

(72) Inventor: Martin MANGINO, RICHMOND, VA (US)

(21) Appl. No.: 18/872,825

(22) PCT Filed: Jun. 13, 2023
(86) PCT No.: PCT/US2023/025103

§ 371 Date: Dec. 8, 2024

Related U.S. Application Data
(60) Provisional application No. 63/352,509, filed on Jun. 15, 2022.

(51) Int. Cl. A01N 1/126

(52) U.S. Cl. CPC A01N 1/126

(57) ABSTRACT

Provided herein are methods for fluid resuscitation of an organ donor. The method includes administering intra-venously to the organ donor an organ protectant solution comprising polyethylene glycol polymers (PEG) with a molecular weight of 18,000-40,000 Da at a concentration of 5-15% w/v. The methods are suitable for protecting organs prior to transplantation.

### FIELD OF THE INVENTION

The disclosure provides organ protectant solutions containing polyethylene glycol polymers useful for fluid resuscitation of an organ donor.

### BACKGROUND

The current shortage of donor organs is well documented though significant advances have been recently made to increase the donor pool. Currently, most of the organ grafts are recovered from donation after brain death (DBD) donors. Though considered more optimal than donation after cardiac death (DCD) donors, DBD also has its set of challenges as brain death has many physiologic consequences that require attention until organs are procured. Brain death often results in acute increase in intracranial pressure causing a Cushing reflex, which initially manifests as acute malignant hypertension as the brain stem herniates through the base of the skull. Increased intracranial pressure causes cerebral ischemia and irreversible hypoxic injury. This results in cessation of peripheral sympathetic outflow and massive peripheral vasodilation, which manifests itself as severe systemic hypotension [1]. In addition, brain death stops the antidiuretic hormone (ADH) release from the supraoptic nucleus causing rapid onset diabetes insipidus [2, 3]. This leaves the patient vulnerable to polyuria ultimately leading to hypovolemia and hyponatremia, which further exacerbates the hypotension. While 95% of brain dead patients are hemodynamically unstable, most donors can have successful organ and tissue procurement [4]. The detrimental effects of hemodynamic instability in potential donors are well documented. In Brazil, one study showed that nearly 62% of the potential donors were lost due to cardiovascular collapse [5]. In the U.S., nearly 25% of the possible organ donations were lost due to an absence of proper physiologic support while another study showed that 97% of successful donors required pharmacological and volume support [2, 6].

Therefore, it is imperative that potential donors are sufficiently resuscitated and stabilized during the procurement process to ensure higher quality of donors and recovered grafts. One institution adopted a protocol which included aggressive fluid resuscitation and use of vasopressors to achieve a mean arterial pressure (MAP) over 70 mmHg and increased the number of organs for procurement by 71% [7]. However, the procurement teams must be judicious in the use of intravenous fluid and vasopressors. Others have shown that the use of vasopressor in the resuscitation of the kidney donor was associated with postoperative acute tubular necrosis, delayed graft function (DGF) of the donor kidney, and decreased renal allograft function at 1 year [8-10]. There have been studies that suggested an indiscriminate use of low dose dopamine may be helpful to prevent DGF of the donor kidney, but this is believed to be due to its antioxidant properties rather than its vasoconstrictive effects [11]. In addition, fluid resuscitation is critical in treating hypotension in a brain dead donor with diabetes insipidus. Currently, isotonic crystalloid is recommended with colloid such as albumin being used as necessary [12]. Hydroxyethyl starch has been shown to increase the risk of DGF of the donor kidney and is not currently used [13, 14]. The volume status of the donor must be carefully controlled to preserve the lung [15]. However, volume restriction in the donor to optimize the lung must be achieved without risking injuries to other organs [16].

Novel intravascular volume controlling agents which reduce preservation injury in brain dead organ donors are needed.

### SUMMARY

Provided herein are organ preservation solutions containing PEG-20K which are used in the resuscitation and support of a brain dead organ donor. The compositions and methods described herein simplify the care of the brain dead donor before recovery and improve end organ preservation by maintaining superior perfusion and tissue volume control.

One aspect of the disclosure provides a method for fluid resuscitation of an organ donor comprising administering intravenously to said organ donor an organ protectant solution comprising polyethylene glycol polymers (PEG) with a molecular weight of 18,000-40,000 Da at a concentration of 5-15% w/v. In some embodiments, the organ donor is a Donation after Brain Death (DBD) organ donor. In some embodiments. the organ protectant solution is administered in an amount sufficient to maintain a mean arterial pressure of 60 to 100 mmHg. In some embodiments, the mean arterial pressure is maintained for a period of 12-72 hours. In some embodiments, the organ protectant solution contains PEG with a molecular weight of 20,000 Da. In some embodiments, the method further comprises intravenously administering vasopressors and/or crystalloids to the organ donor. In some embodiments, the amount of vasopressors and/or crystalloids administered to the organ donor is decreased as compared to the amount that would be needed if the vasopressors and/or crystalloids were administered without PEG.

Another aspect of the disclosure provides a method for protecting organs for transplantation comprising administering to a DBD organ donor an organ protectant solution comprising PEG with a molecular weight of 18,000-40,000 Da at a concentration of 5-15% w/v; maintaining circulation of said DBD organ donor for a suitable period of time, and removing surgically said organs of said DBD organ donor. In some embodiments, the organs are selected from the group consisting of kidney, liver, small bowel, pancreas, pancreatic islets, lung, heart, heart-lung en-bloc, and skin.

Additional features and advantages of the present invention will be set forth in the description of disclosure that follows, and in part, will be apparent from the description of may be learned by practice of the disclosure. The disclosure will be realized and attained by the compositions and methods particularly pointed out in the written description and claims hereof.

### BRIEF DESCRIPTION OF THE DRAWINGS

FIGS. 1A-D. Comparison of (A) MAP, (B) HR, (C) Lactate and (D) Hb Trends. The control and the study groups both had comparable MAP, Hb, and lactated throughout the experiment. Due to hemodilutional effect of PEG-20k, the study group's Hb level trended lower. No statistical differences were detected analyzing data within time points between the two groups. All P values were >0.05 and the degrees of freedom was 5 by unpaired T-test. Within group changes by 1 way ANOVA were not determined because of the study objectives. Values are mean ±SD.

FIGS. 2A-B. Comparison of (A) Epinephrine and (B) Arginine-Vasopressin (AVP) Requirements. Though the AVP infusion requirement was comparable between the two groups, the study group required significantly less epinephrine than the control group to maintain the goal MAP of 80 to 100. For analysis of epinephrine results, P=0.0104, T=3.233, with df=9. For analysis of AVP. T=0.742. T=0.339, with df=9. Values are mean ±SD.

FIGS. 3A-B. Comparison of (A) Intravenous Fluid (IVF) and (B) Potassium Requirements. The study group required less IVF and potassium than the control group to maintain the goal MAP of 80 to 100 and potassium level, respectively. For analysis of intravenous fluid results, P=0.0001, T=10.07. with df=9. For analysis of potassium results, T=0.015, T=4.486, with df=9. Values arc mean ±SD.

FIGS. 4A-B. Comparison of (A) Urine Output and (B) Net Fluid Balance over 16 Hours. Though the net fluid balance difference was negligible, the study group had significantly less urine output than the control group. For analysis of urine output results, P=0.0001, T=9.051, with df=9. For analysis of net fluid balance results, T=0.2145, T=1.335, with df=9. Values are mean ±SD.

FIGS. 5A-B. Comparison of (A) Creatinine Clearance and (B) LDH in the IPK Model. The cold storage kidneys treated with PEG-20k had significantly lower LDH level and higher creatinine clearance than the control group. In addition, the PEG-20k group showed comparable creatinine clearance when compared to the donor kidneys without cold storage. For analysis of GFR data, a one way ANOVA was used with Dunnet's multiple comparison correction. The ANOVA P values was 0.0129. The q value between the control LR brain dead donor dogs with cold storage injury and the PEG-20k treated brain dead donor dogs with cold storage injury was 2.704 and for the control donor dogs with cold storage injury with the contralateral kidneys from donor dogs without cold storage injury was 3.379. The critical q value required at P=0.05 is 2.500. For analysis of the LDH results, P=0.0379, T=2.483, with df=8. Values are mean ±SD.

FIG. 6. Comparison of Proteinuria Using the IPK Model. The proteinuria in the control and the study groups were not significantly different. For analysis of proteinuria results, P=0.747, T=0.346, with df=7. Values are mean ±SD.

### DETAILED DESCRIPTION

Embodiments of the present disclosure are directed toward methods for fluid resuscitation of an organ donor. The method includes intravenously administering an organ protectant solution comprising polyethylene glycol polymers (PEG).

The organ protectant solution comprises polyethylene glycol (PEG) polymers with a molecular weight of about 18,000-40,000 Da. Without being bound by theory, some specifically sized PEG polymers (18,000-40,000) are effective because of two phenomena: 1) they are impermeant molecules with partial oncotic properties. and 2) they are highly hydrophilic and attract water molecules. Tracer studies suggest that the osmotic reflection coefficient (od) of PEG with a molecular weight of 20,000 Da (PEG-20k) is about 0.5, which means that for every 2 molecules of PEG-20k that stays in the capillary space, 1 exits and enters the interstitial space. None get into the cell because it is an impermeant. This creates the osmotic gradients to establish non-energetic transfer of isotonic water out of the cell and into the capillary. This water transfer promotes decompression of the capillary bed that decreases resistance to flow while reloading the capillaries with volume to enhance driving pressure for flow. PEG polymers are extremely hydrophilic and avidly attract water shells around the molecule. This potentiates the water pull over just the osmotic gradients. The organ protectant solution contains PEG at a concentration of 5-15% w/v. e.g. 5%, 6%, 7%, 8%, 9%, 10%, 11%, 12%, 13%, 14%, or 15% w/v.

Most PEGs include molecules with a distribution of molecular weights (i.e. they are polydisperse). The size distribution can be characterized statistically by its weigh average molecular weight (Mw) and its number average molecular weight (Mn), the ratio of which is called the polydispersity index (Mw/Mn). In some embodiments, the polydispersity index is less than about 5. e.g. less than 4, 3, 2, 1.5. or 1.2, e.g. from about 0-5, e.g. from about 0-1.5.

The organ protectant solution and method described herein may contain or not one or more additional components or administration parameters as described in U.S. Pat. Nos. 9,399,027; 10,300,029; and 11,007,227 incorporated herein by reference.

PEG-20k is a hybrid molecule that has both cell impermeant and colloid properties. When given intravenously, the molecule partially diffuses into the interstitium as an impermeant (30%) because it does not penetrate cell membranes and partially remains within the capillary as a colloid (70%). Due to its unique properties as a hybrid molecule, PEG-20k decreases metabolic cell swelling from ischemia while expanding the intravascular volume, thereby increasing the oxygen delivery to the end organs by significantly increasing tissue perfusion.

The PEG may be dissolved or dispersed in water, e.g. deionized water. In some embodiments, the composition is a saline or lactate ringer's solution and comprises one or more of sodium chloride, sodium lactate, sodium bicarbonate, potassium chloride, calcium chloride, calcium gluconate, and magnesium chloride.

Buffering agents may be added to maintain the solution near or within a physiological range of from about 7.3 to about 7.5 (e.g. about 7.35 to about 7.45), e.g. one or more biologically compatible buffering agents such as HEPES, cholamine chloride, MPOS, BES, TES, DIPSO, phosphate salts of sodium or potassium, bicarbonate, Tris, etc.

The organ protectant solution may be a single phase solution, a dispersion, an emulsion, or any other form physically suitable for delivery to the subject. The solution is “physiologically acceptable” in that it is suitable for injection into the subject without causing undue deleterious effects. The solution may comprise autologous blood or a blood substitute. In some embodiments, the solution comprises additional cell impermeants or oncotic agents.

The organ protectant solution may be provided as an intravenous infusion product comprising a bag configured for delivering fluid intravenously and a solution as described herein within the bag. Suitable IV infusion bags, such as Viaflex® bags, are well known in the art.

The organ protectant solutions described herein are useful to treat organ and tissue preservation injury by administration to organ donors after declaration of brain death (DBD-donation after brain death) or after declaration of cardiac death (DCD-donation after cardiac death). These solutions reduce preservation injury to transplanted organs including kidney, liver, small bowel, pancreas, pancreatic islets, lung, heart, heart-lung en-bloc, and skin when administered early (e.g. after declaration of cardiac or brain death) by one or more IV administrations to the donor over the cardiac or brain death period before organ retrieval. The solutions containing PEG polymers stabilize the hemodynamic state of the cardiac or brain dead donor by maintaining blood pressure and local circulation (by reducing cell swelling) thereby reducing the amount of needed support drugs given to these subjects before organ retrieval to keep them alive. Thus, a method for protecting organs for transplantation includes administering an organ protectant solution as described herein; maintaining circulation of the organ donor for a suitable period of time, and removing surgically the organs of the organ donor. In some embodiments, the organ protectant solution is administered in an amount sufficient to maintain a mean arterial pressure of 80 to 100 mmHg. In some embodiments, the mean arterial pressure is maintained for a period of 10-72 hours, e.g. about 14-18 hours, e.g. about 16 hours. In some embodiments, the organ protectant solution is provided at an infusion rate of about 0.3-1.5 ml/hr, e.g. about 0.5-0.8 ml/hr.

The term “organ donor” or “subject” generally refers to any mammal, typically humans. The organ protectant solutions and methods described herein also have veterinary applications including, but not limited to, companion animals and farm animals.

As used herein, the terms “effective amount,” or “sufficient amount” refer to a nontoxic but sufficient amount of an agent to provide the desired biological result. That result may be reduction and/or alleviation of the signs, symptoms, or causes of a disorder, or any other desired alteration of a biological system, such as the reduction or inhibition of metabolic cell and tissue swelling during resuscitation, reduction or prevention of hypotension, or reduction or prevention of diabetes insipidus.

In further embodiments, the methods described herein may further comprise intravenously administering vasopressors and/or crystalloids to the organ donor. Exemplary vasopressors include. but are not limited to, sympathomimetics such as epinephrine, noradrenaline, phenylephrine, dobutamine, dopamine, etc.; vasopressin; glucocorticoids and mineralocorticoids such as hydrocortisone, prednisone, prednisolone, dexamethasone, betamethasone, and fludrocortisone; cardiac glycosides; and PDE3 inhibitors. Exemplary crystalloids include, but are not limited to saline or lactate ringer's solution. Such solutions may or may not contain colloids, such as albumin, hydroethyl starch (HES), Hetastarch, or Hextend.

The vasopressors and/or crystalloids may be administered simultaneously or sequentially to the organ protectant solution. In some embodiments, the organ protectant solution is administered continuously to the organ donor, e.g. for 10-72 hours prior to organ removal, and the one or more vasopressors and/or crystalloids are administered as needed, e.g. at discrete time intervals within the 10-72 hours, in order to maintain a mean arterial pressure of 60 to 100 mmHg.

In some embodiments, the amount of vasopressors and/or crystalloids administered to the organ donor is decreased as compared to an amount of vasopressors and/or crystalloids that would need to be administered without PEG in order to maintain a mean arterial pressure of 60 to 100 mmHg. In some embodiments, the decreased amount is statistically significant. In some embodiments, the amount of vasopressors and/or crystalloids required with PEG is 1×, 2×, 3×, 4×, 5×, 6×, 7×, 8×, 9×, or 10× less than the amount that would be required without PEG.

It is to be understood that this invention is not limited to any particular embodiment described herein and may vary. It is also to be understood that the terminology used herein is for the purpose of describing particular embodiments only, and is not intended to be limiting, since the scope of the present invention will be limited only by the appended claims.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order, which is logically possible.

### EXAMPLE

### Summary

Traditionally, vasopressors and crystalloids have been used to stabilize brain dead donors; however, the use of crystalloid is fraught with complications. This study aimed to investigate the effectiveness of a newly developed impermeant solution, polyethylene glycol-20k IV solution (PEG-20k) for resuscitation and support of brain dead organ donors. Brain death was induced in adult beagle dogs and a set volume of PEG-20k or crystalloid solution was given thereafter. The animals were then resuscitated over 16 hours with vasopressors and crystalloid as necessary to maintain mean arterial pressure of 80 to 100 mmHg. The kidneys were procured and cold-stored for 24 hours, after which they were analyzed using the isolated perfused kidney model. The study group required significantly less crystalloid volume and vasopressors while having less urine output and requiring less potassium supplementation than the control group. Though the two groups' mean arterial pressure and lactate levels were comparable, the study group's kidneys showed less preservation injury after short-term reperfusion indexed by decreased lactate dehydrogenase release and higher creatinine clearance than the control group. The use of polyethylene glycol-20k IV solution for resuscitating brain dead donors decreases cell swelling and improves intravascular volume, thereby improving end organ oxygen delivery before procurement and so preventing ischemia-reperfusion injury after transplantation.

### Materials and Methods

### Animal Preparation

This study was approved by the Virginia Commonwealth University's Institutional Animal

Care and Use Committee. Adult beagle dogs (8-10 kg) of either sex (n=11) were initially anesthetized with propofol (10 mg/kg, intravenous or IV). After intubation, anesthesia was maintained with isoflurane at 1-2% on mechanical ventilation with FiO2 at 30%, ventilation rate of 12, which was adjusted as necessary to achieve a PaCO2 goal of 38-42 mmHg. A circulating water-warming pad was used to maintain normothermia throughout the experiment. The femoral artery was cannulated for arterial blood sampling and for measurement of arterial blood pressure and heart rate. The external jugular vein was also accessed and cannulated for administration of fluids and necessary medications.

### Induction of Brain Death

Explosive brain death was induced in anesthetized adult Beagle dogs by inflating a balloon catheter (16 Fr. Foley) that was placed under the skull from a trephination burr hole. The balloon was inflated from 0-8 ml volume over about 5 minutes. which ultimately causes the brain stem to herniate through the foramen at the base of the skull. This causes rapid brain death that is characterized by the occurrence of a Cushing reflex, a negative apnea reflex, and fixed and dilated pupils. This methodology has previously been described by Mangino, et al.

### Experimental Design

The animals were assigned to either the control group (n=5) or the PEG-20k group (n=6) within the first hour. Both groups were treated in a standard fashion. The initial rates of LR (B. Braun Medical Inc, Bethlehem, PA, USA, 20 ml/kg/hr), epinephrine (2 μg/kg/hr), and vasopressin (0.1 U/kg/hr) infusions which were started 10 minutes after the diagnosis of brain death were adjusted to maintain a MAP goal of 80-100 mmHg over the 16 hour ICU period. At the one-hour mark, the control group received a LVR bolus (6.8 ml/kg) of LR solution over 10 min followed by the continuous IV of LR at 0.68 ml/hr. The intervention group received the same rate bolus and constant IV infusion of a 10% PEG-20k IV solution (Sigma-Aldrich®, St. Louis, Missouri, USA) in place of LR. Both groups received epinephrine and vasopressin with the MAP goal of 80-100 mmHg for 16 hours. For both groups, intravenous infusion of calcium gluconate. KCl, sodium bicarbonate, and NaCl was given as necessary to maintain normal electrolyte levels. Outcomes during donor management included the amount of additional fluid and pressors required, the urine output, and potassium and calcium repletion required to maintain normal limits.

Following the 16-hour brain death period, one kidney from each animal was flushed with 100 ml cold University of Wisconsin (UW) solution and cold-stored for 24 hours while the other was analyzed immediately after recovery to serve as a fresh comparison. An isolated perfused kidney (IPK) model of rewarming and reperfusion was used to simulate transplantation and to measure the short-term renal function over an hour to assess the degree of renal preservation injury. This model was previously validated in rodent model of kidney transplant to predict changes associated with renal organ preservation injury. [a] A warm, acellular Krebs bicarbonate buffer solution was oxygenated and pumped through the renal artery for a 1-hour reperfusion period, and oxygen consumption, vascular resistance, proteinuria, lactate dehydrogenase (LDH) release, and creatinine clearance (estimated glomerular filtration rate or GFR) were measured. Oxygen consumption of the kidney was calculated using the Fick's principle by measuring the partial pressures of oxygen in the arterial and venous buffer samples and arterial perfusate inflow rates. Proteinuria was measured with the Bicinchoninic assay (BCA). LDH in the perfusate was measured spectrophotometrically and was used to measure changes in cell membrane permeability and lysis. GFR was estimated by the clearance of creatinine. Perfusion pressure was measured by a fluid filled T-catheter in the arterial perfusate inflow lines. Perfusate flow was measured using a transit time flow probe inserted into the arterial inflow line. Temperature of the kidney was maintained at 36-38 degrees centigrade by heating the buffer with a heat exchanger and directly by heating lamps on the kidney.

### Statistical Analysis

Descriptive statistics were first calculated along with sample distribution analysis. With few exceptions, parametric data analysis were done by using a parametric ANOVA followed by a Bonferroni correction. Nonparametric data (transformed values such as vascular resistance) were analyzed by the Kruskal-Walis test. Linear regression analysis was used for standard curves used in chemical assays. A P value of less than or equal to 0.05 was considered statistically significant. Each group consisted of 6 dogs but one dog in the control group was lost due to surgical complications during brain death induction.

### Results

### Arterial Blood Pressure, Heart Rate, Plasma Lactate, and Hemoblobin

The average baseline parameters (baseline defined as values prior to induction of brain death) such as MAP, heart rate (HR), hemoglobin (Hb) and lactate of both groups were comparable.

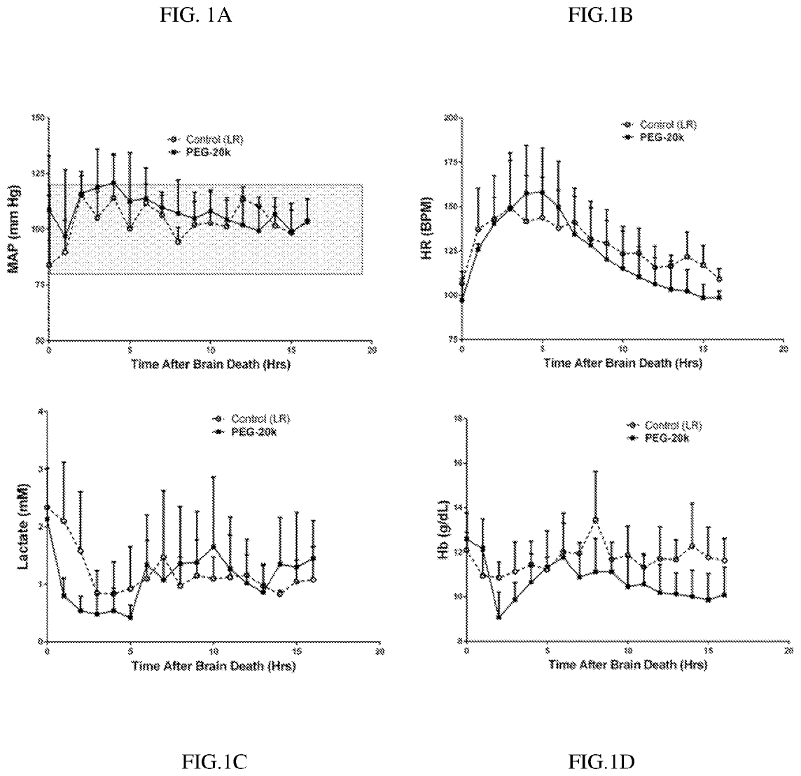

All animals survived for the duration of the 16 hours of resuscitation. With the exception of heart rate, measurements of end organ perfusion such as MAP and lactate remained comparable throughout the 16 hours of resuscitation after brain death (FIGS. 1A-D). At the end of the experiment (defined as the time point immediately before the bilateral kidneys were procured), there were no statistical differences in the MAPs and the lactate levels of the control and the study group (103.8±9.6 vs. 103.2±10.5 mmHg for MAP, p>0.05; 1.08±0.6 vs. 1.45±0.7 mM for lactate, p>0.05). The baseline parameters aside from the HR were comparable between the control and the study groups.

### Drugs Required to Maintain Constant Blood Pressure

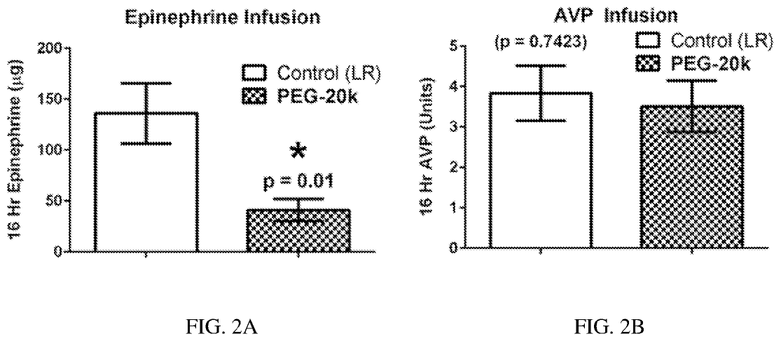

To achieve standardized MAP, each animal was given necessary crystalloid or PEG-20k, epinephrine and arginine vasopressin (AVP). The total amount of epinephrine given over the 16 hours of resuscitation was statistically different in the two groups (136.0±66.6 vs. 41.1±26.5 mg, p<0.05, FIG. 2A).

### Intravascular Fluid Volume and Potassium Requirements

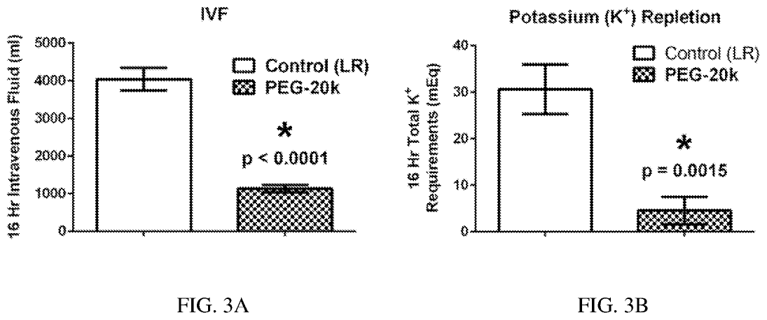

The control group received significantly more volume of IVF than the study group (4045.6±670.3 vs. 1136.3±224.46 mL, p<0.05; FIG. 3A). Accordingly, the study group required significantly lower potassium repletion than the control group to maintain physiological plasma concentrations of potassium (4.5±7.3 vs. 30.6±11.9 mEq, p<0.05; FIG. 3B).

### Urine Output and Fluid Balance

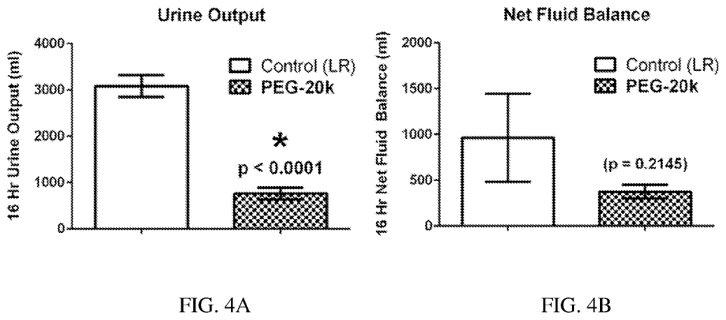

Both groups received comparable amount of AVP (3.8±1.5 vs. 3.5±1.6 mg, p>0.05; FIG. 2B). However, the study group had significantly lower total urine output over 16 hours of resuscitation than the control group (762.8±310.8 vs. 3081.8±531.1 mL, p<0.05; FIG. 4A). The net fluid balance in both groups were statistically similar even though a trend towards a less positive balance is seen in the PEG-20k treated group, relative to the control LR group (FIG. 4B).

Renal Preservation Injury after Cold Storage

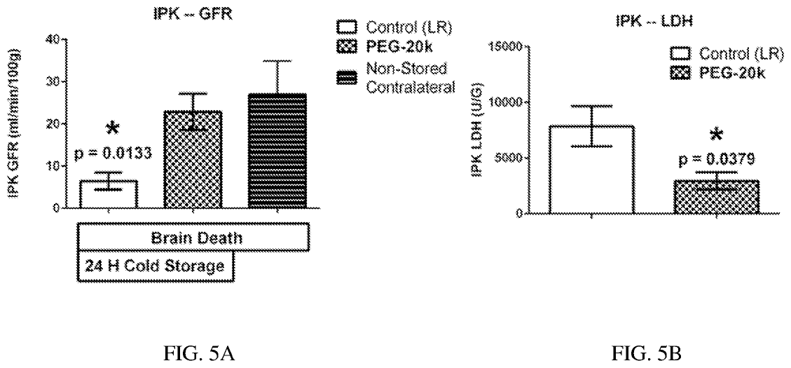

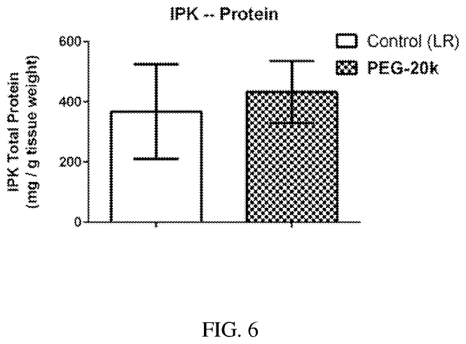

Renal preservation injury was assessed in cold stored kidneys from both groups by measuring functional and biochemical outcomes during perfusion on the isolated perfused kidney (IPK) apparatus. The cold-stored kidneys of the PEG-20k group had significantly higher creatinine clearance, relative to the cold-stored kidneys of the control group (22.9±8.5 vs. 6.5±4.0 ml/min. p<0.05). The GFR in the treated cold stored kidneys was not different from non-injured kidneys (22.9±8.5 vs. 27.0±13.7 ml/min, FIG. 5A). The cold storage kidneys treated with PEG-20k also released significantly less LDH into the perfusion buffer than the control group (2960.2±1707.6 vs. 7857.80±4065.85 U/g. p<0.05) (FIG. 5B). The difference in proteinuria in the groups was not statistically significant (FIG. 6).

### Discussion

### Interpretations

This is the first preclinical study that demonstrates the superior outcome of PEG-20k in the preservation of the donor kidney function compared to crystalloid. Both groups had comparable end organ perfusion throughout the experiment as measured by MAP and lactate (FIGS. 1 and 2). At the conclusion of the experiment, though both donor groups had MAP above 100 and lactate below 2, which are indicative of successful resuscitation, the study group required less IVF and vasopressors to achieve this. In addition, kidney grafts treated with PEG-20k had significantly higher creatinine clearance and lower LDH level than the control group. Both assays suggest that though macro-hemodynamic goals may be met, the preservation of the graft function can remain elusive. Our results suggest that PEG-20k is a better resuscitation fluid than crystalloid in preserving the graft function. This is highly impactful in transplantation as DGF is associated with significant morbidity and mortality. [23] [24] [25] [26] DGF is associated with decreased short and long-term survival of the graft and may contribute to both acute and chronic rejection. [24 ] [25].

Maintaining a physiological environment of the donor organs until procurement is challenging in the DBD condition; central vasomotor neural control of vascular tone is lost after the onset of Cushing reflex, resulting in a massive vasodilatation and decreased blood pressure. The concomitant loss of vasopressin release from the hypothalamus compounds the dilatation and promotes massive loss of sodium and water across the kidneys, causing hypovolemia and further amplifying decreased end organ perfusion. The traditional approach to treat these issues is to infuse vasoconstrictors to raise blood pressure and replace large volumes of water and electrolytes lost in the urine with IV crystalloid infusions. The administration of AVP is used to retard the loss of urinary sodium and water loss but it also causes regional vasoconstriction. Using macrohemodynamics as the endpoint for patient management under these conditions may jeopardize the organs needed to be preserved for transplantation, because norepinephrine and AVP regionally limit perfusion to increase central blood pressure, thereby compromising end organ perfusion. Since the end goal is to preserve end organ perfusion rather than reaching a target central blood pressure. it is imperative to target tissue perfusion in the management of brain dead donors to preserve the function of the donor organs rather than the macro-hemodynamic numbers.

A new IV resuscitation solution developed for shock resuscitation uses inert cell impermeant polymers to increase tissue perfusion. PEG-20k in these solutions treats ischemia by preventing or reversing metabolic cell swelling. During cell ischemia, oxygen delivery decreases and the aerobic ATP synthesis stops. As a result, the Na-K ATPase pump slows and sodium leaks back into the cells and tissues followed by water. This results in cellular and tissue metabolic swelling. As the tissues swell, they impose higher transmural forces across embedded tissue capillary networks, thereby increasing vascular resistance while decreasing perfusion and oxygen delivery. Furthermore, diabetes insipidus results in an impaired water reabsorption in the kidney, ultimately leading to hypovolemia and tissue malperfusion through reduced driving pressure gradients for flow.

The PEG-20k polymer is designed to do the intended work of large volume IV infusions and vasoconstrictor amines but without their side effects. Due to its unique size and hydrophilic properties, PEG-20k distributes unequally in the microcirculation and creates multiple osmotic gradients favorable for unidirectional water to flow out of the cells back into the capillaries. As a result, isotonic water is transferred from places where it is not supposed to be (the intracellular and interstitial spaces) into areas where it should be (the intravascular space). This restores tissue perfusion by reloading the intravascular volume and decompressing the capillary beds. This volume expansion effect is reflected by the significantly lower requirements for vasopressors required in the study group compared to the control. The study group then had greater volume and less regional vasoconstriction, which increases convective and diffusional oxygen transfer out of the capillaries into the mitochondria of the cells. This theoretically limits downstream ischemia-reperfusion injury when the organs are recovered by preserving tissue ATP stores through maintained aerobic perfusion and metabolism during the donor management phase. Better organ performance at reperfusion indirectly supports this in lieu of direct ATP measurements in the donor organs at recovery.

There may be significant beneficial effects of PEG-20k specific to the kidney. PEG-20k polymers may change local starling forces in the peritubular capillary network favoring fluid reabsorption and limiting urine output. Furthermore, the reduction in the IVF requirement to maintain blood pressure results in less urine production. This effect serves to offset the diabetes insipidus induced after brain death, as shown by the 4 to 5 fold decrease in urine production during the donation period and a proportional decrease in crystalloid volume replacement in this study. We suspect that the reduction of volume of IVF during long donor recovery cases also limits the extent of injury of the endothelial glycocalyx of recovered organs as crystalloid overuse is known to crode the components of the glycocalyx and unmask adhesion receptors [27]. This may further reduce the post-transplant cellular inflammation of the donor organ by decreasing the binding sites of the vascular endothelium for immune competent cells, which is a driver of organ preservation injury. In addition, PEG-20k may have downstream anti-inflammatory effects, possibly by an immune-camouflage mechanism, as we have shown previously in hemorrhagic shock [1].

Novel polymer resuscitation of donors improved donor management and the quality of the donor organs recovered. Kidneys in the DBD group performed better in the IPK apparatus when the donors were managed with PEG-20k compared to standard management techniques. Although this assay has a limited resolution, renal grafts from donors treated with PEG-20k solution had significantly higher GFR estimates in the first hour of reperfusion compared to renal grafts from the controls treated with crystalloid infusion. In fact, the graft had the same GFR as non-stored contralateral control kidneys. The release of LDH from the kidneys during early reperfusion, which is a surrogate for tissue and cell injury, was 3-fold less in the PEG-20k treated donors, which is suggestive of less tissue damage. This data demonstrates that renal allografts recovered from PEG-20k treated brain dead donors may suffer less preservation injury compared to renal grafts from donors who had received standard care. The mechanisms may be due to better tissue perfusion during the brain death phase of donation with less tissue injury before the procurement and then during the reperfusion after cold storage ischemia. Given that the IPK reperfusion phase uses an acellular crystalloid without any neutrophils or mononuclear cells, post-reperfusion cellular inflammation changes are likely not a factor. However, PEG-20k may have reduced inflammation through nonspecific surface passivation of the glycocalyx or circulating immune competent cells in the donor after brain death, protecting the grafts at the time of reperfusion.

### Conclusions

In conclusion, IV infusion of PEG-20k during the resuscitation of brain dead donors resulted in a superior outcome of donor kidney function compared to the crystalloid. This is thought to be due to PEG-20k's unique hybrid properties (colloidal and impermeant) which decreases cell swelling and increases intravascular volume more efficiently than crystalloid. This in turn drastically improves macro-and microcirculation and the end organ perfusion while reducing the use of additional crystalloid and vasopressors. Ultimately, when the organ is procured, there is less ischemic injury, thereby affording superior organ preservation and superior function at reperfusion after transplantation. These observations in kidney are likely applicable to all organs that are procured for transplantation.

### REFERENCES

1. Wood K E, Becker B N, McCartney J G, D'Alessandro A M, Coursin DB. Care of the potential organ donor. N Engl J Med. 2004;351(26): 2730-9. Epub 2004 Dec. 24. doi: 10.1056/NEJMra013103. PubMed PMID: 15616207.
2. Salim A, Martin M, Brown C, Belzberg H, Rhee P, Demetriades D. Complications of brain death: frequency and impact on organ retrieval. Am Surg. 2006;72(5): 377-81. Epub 2006 May 25. PubMed PMID: 16719188.
3. Howlett T A, Keogh A M, Perry L, Touzel R, Rees L H. Anterior and posterior pituitary function in brain-stem-dead donors. A possible role for hormonal replacement therapy. Transplantation. 1989;47(5): 828-34. Epub 1989 May 1. doi: 10.1097/00007890-198905000-00016. PubMed PMID: 2718243.
4. Naja Zadeh K, Radpei B, Ghorbani F, Hamidinia S, Ghobadi O, Kardavani B, et al. Our experience with organ procurement from hemodynamically unstable brain dead patients. Ann Transplant. 2009; 14 (2): 20-3. Epub 2009 Jun. 3. PubMed PMID: 19487789.
5. da Silva Bento P, Santiago A D. Vendrame Saes L S, Erbs Pessoa J L, Ockner Silva T L, Schirmer J, et al. Loss of Potential Donors Due to Hemodynamic Maintenance. Transplant Proc. 2020;52(5): 1226-30. Epub 2020 Mar. 21. doi: 10.1016/j.transproceed.2020.02.020. PubMed PMID: 32192745.
6. Mackersie R C, Bronsther O L, Shackford S R. Organ procurement in patients with fatal head injuries. The fate of the potential donor. Ann Surg. 1991;213(2): 143-50. Epub 1991 Feb. 1. doi: 10.1097/00000658-199102000-00009. PubMed PMID: 1992941; PubMed Central PMCID: PMCPMC1358387.
7. Salim A, Velmahos G C, Brown C, Belzberg H, Demetriades D. Aggressive organ donor management significantly increases the number of organs available for transplantation. J Trauma. 2005;58(5): 991-4. Epub 2005 May 28. doi: 10.1097/01.ta.0000168708.78049.32. PubMed PMID: 15920414.
8. Giral M. Bertola J P. Foucher Y. Villers D. Bironneau E. Blanloeil Y. et al. Effect of brain-dead donor resuscitation on delayed graft function: results of a monocentric analysis. Transplantation. 2007;83(9): 1174-81. Epub 2007 May 15. doi: 10.1097/01.tp.0000259935.82722.11. PubMed PMID: 17496532.
9. Marshall R, Ahsan N, Dhillon S, Holman M. Yang H C. Adverse effect of donor vasopressor support on immediate and one-year kidney allograft function. Surgery. 1996;120(4): 663-5; discussion 6. Epub 1996 Oct. 1. doi: 10.1016/s0039-6060 (96) 80014-6. PubMed PMID: 8862375.
10. O'Brien E A, Bour S A, Marshall R L, Ahsan N, Yang H C. Effect of use of vasopressors in organ donors on immediate function of renal allografts. J Transpl Coord. 1996: 6(4): 215-6. Epub 1996 Dec. 1. doi: 10.7182/prtr.1.6.4.elg711321k55563r. PubMed PMID: 9188388.
11. Mundt H M, Yard B A, Kramer B K, Benck U, Schnulle P. Optimized donor management and organ preservation before kidney transplantation. Transpl Int. 2016;29(9): 974-84. Epub 2015 Nov. 14. doi: 10.1111/tri.12712. PubMed PMID: 26563531.
12. Patel M S, Abt P L. Current practices in deceased organ donor management. Curr Opin Organ Transplant. 2019;24(3): 343-50. Epub 2019 May 16. doi: 10.1097/MOT.0000000000000638. PubMed PMID: 31090647.
13. Patel M S, Niemann C U, Sally M B, De La Cruz S, Zatarain J, Ewing T, et al. The Impact of Hydroxyethyl Starch Use in Deceased Organ Donors on the Development of Delayed Graft Function in Kidney Transplant Recipients: A Propensity-Adjusted Analysis. Am J Transplant. 2015;15(8): 2152-8. Epub 2015 Apr. 24. doi: 10.1111/ajt.13263. PubMed PMID: 25904248.
14. Cittanova M L, Leblanc I, Legendre C, Mouquet C, Riou B, Coriat P. Effect of hydroxyethylstarch in brain-dead kidney donors on renal function in kidney-transplant recipients. Lancet. 1996;348(9042): 1620-2. Epub 1996 Dec. 14. doi: 10.1016/s0140-6736(96) 07588-5. PubMed PMID: 8961992.
15. Rosengard B R, Feng S, Alfrey E J, Zaroff J G, Emond J C, Henry M L, et al. Report of the Crystal City meeting to maximize the use of organs recovered from the cadaver donor. Am J Transplant. 2002;2(8): 701-11. Epub 2002 Sep. 24. doi: 10.1034/j.1600-6143.2002.20804.x. PubMed PMID: 12243491.
16. Minambres E, Rodrigo E, Ballesteros M A, Llorca J, Ruiz J C, Fernandez-Fresnedo G, et al. Impact of restrictive fluid balance focused to increase lung procurement on renal function after kidney transplantation. Nephrol Dial Transplant. 2010;25(7): 2352-6. Epub 2010 Feb. 16. doi: 10.1093/ndt/gfq054. PubMed PMID: 20154365.
17. Parrish D. Lindell S L, Reichstetter H, Aboutanos M, Mangino M J. Cell Impermeant-based Low-volume Resuscitation in Hemorrhagic Shock: A Biological Basis for Injury Involving Cell Swelling. Ann Surg. 2016;263(3): 565-72. doi: 10.1097/SLA.0000000000001049. PubMed PMID: 25915911; PubMed Central PMCID: PMCPMC4747844.
18. Parrish D, Plant V. Lindell S L, Limkemann A, Reichstetter H, Aboutanos M, et al. New low-volume resuscitation solutions containing PEG-20k. J Trauma Acute Care Surg. 2015;79(1): 22-9. doi: 10.1097/TA.0000000000000682. PubMed PMID: 26091310; PubMed Central PMCID: PMCPMC4476060.
19. Plant V. Limkemann A, Liebrecht L, Blocher C, Ferrada P, Aboutanos M, et al. Low-volume resuscitation using polyethylene glycol-20k in a preclinical porcine model of hemorrhagic shock. J Trauma Acute Care Surg. 2016;81(6): 1056-62. doi: 10.1097/TA.0000000000001155. PubMed PMID: 27280940; PubMed Central PMCID: PMCPMC5121040.
20. Plant V, Parrish D W, Limkemann A, Ferrada P, Aboutanos M, Mangino M J. Low-Volume Resuscitation for Hemorrhagic Shock: Understanding the Mechanism of PEG-20k. J Pharmacol Exp Ther. 2017;361(2): 334-40. doi: 10.1124/jpet.116.239822. PubMed PMID: 28275202.
21. Khoraki J W, N.; Kang, H. S.; Xu. H.: Archambault, C.; Blocher, C.; Li, R.; Liebrecht, L.; Aboutanos, M.; Mangino, M. J. Superior Survival Outcomes of a Polyethylene Glycol-20k Based Resuscitation Solution in a Preclinical Porcine Model of Lethal Hemorrhagic Shock Annals of Surgery. 2020; In Press.
22. Mangino M J, Kosieradzki M. Gilligan B, Woo H, Southard J H. The effects of donor brain death on renal function and arachidonic acid metabolism in a large animal model of hypothermic preservation injury. Transplantation. 2003;75(10): 1640-7. Epub 2003 Jun. 5. doi: 10.1097/01.TP.0000062541.10466.16. PubMed PMID: 12777849.
23. Sanfilippo F. Vaughn W K, Spees E K, Lucas B A. The detrimental effects of delayed graft function in cadaver donor renal transplantation. Transplantation. 1984;38(6): 643-8. Epub 1984 Dec. 1. doi: 10.1097/00007890-198412000-00019. PubMed PMID: 6390827.
24. Ojo A O, Wolfe R A, Held P J, Port F K, Schmouder R L. Delayed graft function: risk factors and implications for renal allograft survival. Transplantation. 1997;63(7): 968-74. Epub 1997 Apr. 15. doi: 10.1097/00007890-199704150-00011. PubMed PMID: 9112349.
25. Nicholson M L, Wheatley T J, Horsburgh T, Edwards C M, Veitch P S, Bell P R. The relative influence of delayed graft function and acute rejection on renal transplant survival. Transpl Int. 1996;9(4): 415-9. Epub 1996 Jan. 1. doi: 10.1007/BF00335705. PubMed PMID: 8819280.
26. Figueiredo A, Moreira P, Parada B, Nunes P, Macario F, Bastos C, et al. Risk factors for delayed renal graft function and their impact on renal transplantation outcome. Transplant Proc. 2007;39(8): 2473-5. Epub 2007 Oct. 24. doi: 10.1016/j.transproceed.2007.07.032. PubMed PMID: 17954150.
27. Smart L, Boyd C J, Claus M A, Bosio E, Hosgood G, Raisis A. Large-Volume Crystalloid Fluid Is Associated with Increased Hyaluronan Shedding and Inflammation in a Canine Hemorrhagic Shock Model. Inflammation. 2018;41(4): 1515-23. Epub 2018 May 8. doi: 10.1007/s10753-018-0797-4. PubMed PMID: 29728805.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

What is claimed is:

1. A method for fluid resuscitation of an organ donor, comprising
administering intravenously to said organ donor an organ protectant solution comprising polyethylene glycol polymers (PEG) with a molecular weight of 18,000-40,000 Da at a concentration of 5-15% w/v; and
administering intravenously to said organ donor one or more vasopressors and/or crystalloids.

2. The method of claim 1, wherein the organ donor is a Donation after Brain Death (DBD) organ donor.

3. The method of claim 1, wherein the organ protectant solution and the one or more vasopressors and/or crystalloids are administered in an amount sufficient to maintain a mean arterial pressure of 60 to 100 mmHg.

4. The method of claim 3, wherein the mean arterial pressure is maintained for a period of 12-72 hours.

5. The method of claim 1, wherein the organ protectant solution contains PEG with a molecular weight of 20,000 Da.

6. The method of claim 1, wherein an amount of vasopressors and/or crystalloids administered to the organ donor is decreased as compared to an amount of vasopressors and/or crystalloids if administered without PEG.

7. A method for protecting organs for transplantation. comprising
administering intravenously to a DBD organ donor an organ protectant solution comprising PEG with a molecular weight of 18,000-40,000 Da at a concentration of 5-15% w/v;
administering intravenously to said DBD organ donor one or more vasopressors and/or crystalloids;
maintaining circulation of said DBD organ donor for a suitable period of time, and
removing surgically said organs of said DBD organ donor.

8. The method of claim 7, wherein the organ protectant solution is administered in an amount sufficient to maintain a mean arterial pressure of 60 to 100 mmHg.

9. The method of claim 7, wherein the suitable period of time is 12-72 hours.

10. The method of claim 7, wherein the organ protectant solution contains PEG with a molecular weight of 20,000 Da.

11. The method of claim 7, wherein an amount of vasopressors and/or crystalloids administered to the DBD organ donor is decreased as compared to an amount of vasopressors and/or crystalloids if administered without PEG.

12. The method of claim 7, wherein said organs are selected from the group consisting of kidney, liver, small bowel, pancreas, pancreatic islets, lung, heart, heart-lung en-bloc, and skin.
